(19) United States
(12) Patent Application Publication
(10) Pub. No.: US 2006/0268965 A1
(43) Pub. Date: Nov. 30, 2006

(54) Method and system for RDS decoder for single chip integrated Bluetooth and FM transceiver and baseband processor

(76) Inventors: Brima Ibrahim, Aliso Viejo, CA (US); Siukai Mak, Poway, CA (US); Theodore A. Trost, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/287,181

(22) Filed: Nov. 22, 2005

Related U.S. Application Data
(60) Provisional application No. 60/685,239, filed on May 26, 2005.

(51) Int. Cl. H04B 1/00

(52) U.S. Cl. 375/149

(57) ABSTRACT

A method and system for an RDS decoder for single chip integrated Bluetooth and FM Transceiver and baseband processor are provided. The RDS decoder may have two phases, an acquisition phase and a decoding phase. During an acquisition phase, synchronization of a bit stream may be established based on detecting at least a portion of a plurality of received radio data service (RDS) data blocks. The synchronized bit stream may then be decoded during the decoding phase. If during decoding, at least a portion of the bit stream is out of synchronization, the bit stream may be synchronized without returning to the acquisition phase.

### CROSS-REFERENCE TO RELATED APPLICATIONS/INCORPORATION BY REFERENCE

The application makes reference to, claims priority to, and claims the benefit of U.S. Provisional Application Ser. No. 60/685,239 filed on May 26, 2005.

This application also makes reference to:

U.S. application Ser. No. 11/176,417 filed on Jul. 7, 2005;

U.S. application Ser. No. ______ (Attorney Docket No. 16663US02) filed on even date herewith;

U.S. application Ser. No. ______ (Attorney Docket No. 17106US02) filed on even date herewith;

U.S. application Ser. No. ______ (Attorney Docket No. 17107US02) filed on even date herewith;

U.S. application Ser. No. ______ (Attorney Docket No. 17108US02) filed on even date herewith;

U.S. application Ser. No. ______ (Attorney Docket No. 17110US02) filed on even date herewith;

U.S. application Ser. No. ______ (Attorney Docket No. 17113US02) filed on even date herewith;

U.S. application Ser. No. ______ (Attorney Docket No. 17115US02) filed on even date herewith; and

U.S. application Ser. No. ______ (Attorney Docket No. 17116US02) filed on even date herewith.

Each of the above stated applications is hereby incorporated herein by reference in its entirety.

### FIELD OF THE INVENTION

Certain embodiments of the invention relate to Bluetooth and FM communication technologies. More specifically, certain embodiments of the invention relate to a method and system for an RDS decoder for single chip integrated Bluetooth and FM Transceiver and baseband processor.

### BACKGROUND OF THE INVENTION

With the popularity of portable electronic devices and wireless devices that support audio applications, there is a growing need to provide a simple and complete solution for audio communications applications. For example, some users may utilize Bluetooth-enabled devices, such as headphones and/or speakers, to allow them to communicate audio data with their wireless handset while freeing to perform other activities. Other users may have portable electronic devices that may enable them to play stored audio content and/or receive audio content via broadcast communication, for example.

However, integrating multiple audio communication technologies into a single device may be costly. Combining a plurality of different communication services into a portable electronic device or a wireless device may require separate processing hardware and/or separate processing software. Moreover, coordinating the reception and/or transmission of data to and/or from the portable electronic device or a wireless device may require significant processing overhead that may impose certain operation restrictions and/or design challenges. For example, a handheld device such as a cellphone that incorporates Bluetooth and Wireless LAN may pose certain coexistence problems caused by the close proximity of the Bluetooth and WLAN transceivers.

Furthermore, simultaneous use of a plurality of radios in a handheld may result in significant increases in power consumption. Power being a precious commodity in most wireless mobile devices, combining devices such as a cellular radio, a Bluetooth radio and a WLAN radio requires careful design and implementation in order to minimize battery usage. Additional overhead such as sophisticated power monitoring and power management techniques are required in order to maximize battery life.

Additionally, when decoding transmitted data, in many systems, data streams need to be synchronized before being decoded. The synchronization and decoding processes may run at different speeds, and often systems run into problems with inefficiencies associated with synchronizing and decoding data. Often, decoders, and other portions in a communications system run out of synchronization, and the system performance is adversely affected by having to re-synchronize data before resuming processes such as decoding. This creates inefficiencies and unnecessary delays in other parts of a communication system, and may reflect on the performance of an associated device.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for an RDS decoder for single chip integrated Bluetooth and FM Transceiver and baseband processor, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary FM transmitter that communicates with handlheld devices that utilize a single chip with integrated Bluetooth and FM radios, in accordance with an embodiment of the invention.

FIG. 1B is a block diagram of an exemplary FM receiver that communicates with handlheld devices that utilize a single chip with integrated Bluetooth and FM radios, in accordance with an embodiment of the invention.

FIG. 1C is a block diagram of an exemplary single chip with integrated Bluetooth and FM radios that supports FM processing and an external device that supports Bluetooth processing, in accordance with an embodiment of the invention.

FIG. 1D is a block diagram of an exemplary single chip with integrated Bluetooth and FM radios and an external device that supports Bluetooth and FM processing, in accordance with an embodiment of the invention.

FIG. 1E is a block diagram of an exemplary single chip with multiple integrated radios that supports radio data processing, in accordance with an embodiment of the invention.

FIG. 1F is a block diagram of an exemplary single chip with integrated Bluetooth and FM radios that supports multiple interfaces, in accordance with an embodiment of the invention.

FIG. 1G is a block diagram of an exemplary single chip with integrated Bluetooth and FM radios that supports interfacing with a handset baseband device and a coexistent wireless LAN (WLAN) radio, in accordance with an embodiment of the invention.

FIG. 2A is a block diagram of an exemplary single chip that supports Bluetooth and FM operations with an external FM transmitter, in accordance with an embodiment of the invention.

FIG. 2B is a block diagram of an exemplary single chip that supports Bluetooth and FM operations with an integrated FM transmitter, in accordance with an embodiment of the invention.

FIG. 2C is a flow diagram that illustrates exemplary steps for processing received data in a single chip with integrated Bluetooth and FM radios, in accordance with an embodiment of the invention.

FIG. 2D is a flow diagram that illustrates exemplary steps for processing FM data via the Bluetooth core in a single chip with integrated Bluetooth and FM radios, in accordance with an embodiment of the invention.

FIG. 2E is a flow diagram that illustrates exemplary steps for configuring a single chip with integrated Bluetooth and FM radios based on the mode of operation, in accordance with an embodiment of the invention.

FIG. 3 is a block diagram of an exemplary FM core and PTU for processing RDS and digital audio data, in accordance with an embodiment of the invention.

FIG. 4 is a block diagram of an exemplary system for RDS subcarrier decoding and demodulation of an RDS signal in a single chip integrated Bluetooth and FM transceiver, in accordance with an embodiment of the invention.

FIG. 5 is a flow diagram that illustrates exemplary steps for processing data in an RDS decoder in a single chip integrated Bluetooth and FM transceiver, in accordance with an embodiment of the invention.

FIG. 6 is a flow diagram that illustrates exemplary steps for data acquisition in an RDS decoder in a single chip integrated Bluetooth and FM transceiver, in accordance with an embodiment of the invention.

FIG. 7 is a flow diagram that illustrates exemplary steps for data decoding in an RDS decoder in a single chip integrated Bluetooth and FM transceiver, in accordance with an embodiment of the invention.

### DETAILED DESCRIPTION OF THE INVENTION

Certain embodiments of the invention may be found in a method and system for an RDS decoder for single chip integrated Bluetooth and FM Transceiver and baseband processor. In RDS decoding, a decoder may have two phases, an acquisition phase and a decoding phase. During an acquisition phase, synchronization of a bit stream may be established based on detecting at least a portion of a plurality of received radio data service (RDS) data blocks. The synchronized bit stream may then be decoded during the decoding phase. If during decoding, at least a portion of the bit stream is out of synchronization, the bit stream may be synchronized without returning to the acquisition phase.

The single chip Bluetooth and FM radio may provide a versatile platform that supports both Bluetooth and FM audio capabilities. For example, a user may have the capability to select from multiple audio-based services without the need to purchase and travel with a plurality of different devices.

Aspects of the method and system may comprise a single chip that comprises a Bluetooth radio, an FM radio, a processor system, and a peripheral transport unit (PTU). FM data may be received and/or transmitted via the FM radio and Bluetooth data may be received and/or transmitted via the Bluetooth radio. The FM radio may receive radio data system (RDS) data. The PTU may support a plurality digital and analog interfaces that provides flexibility with the handling of data. A processor in the processor system may enable time-multiplexed processing of FM data and processing of Bluetooth data. The single chip may operate in an FM-only, a Bluetooth-only, and an FM-Bluetooth mode. The single chip may reduce power consumption by disabling portions of the Bluetooth radio during FM-only mode, disabling analog circuitry when performing digital processing, and/or disabling all FM functions when in BT-only mode. Communication between Bluetooth and FM channels may be enabled via the single chip.

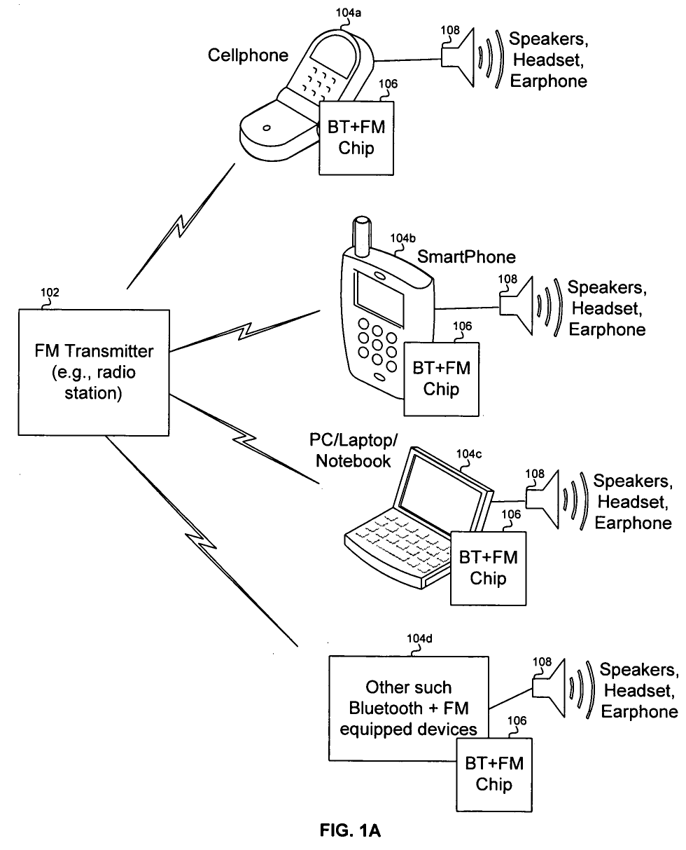

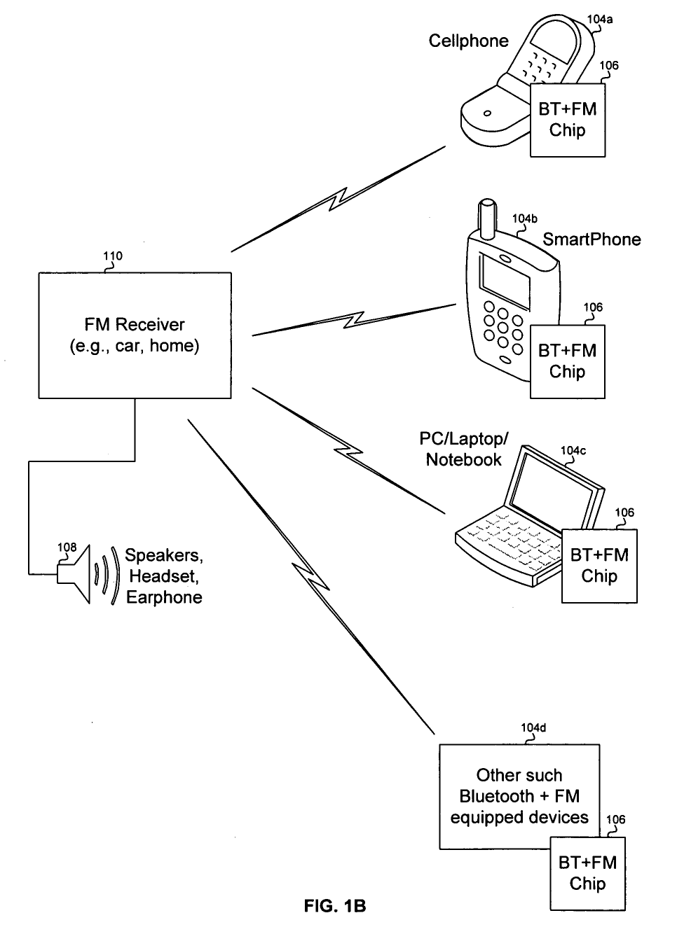

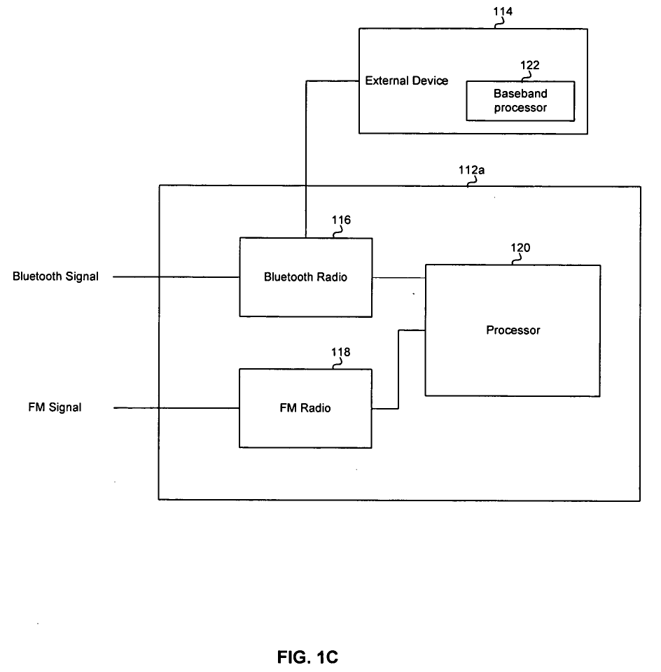

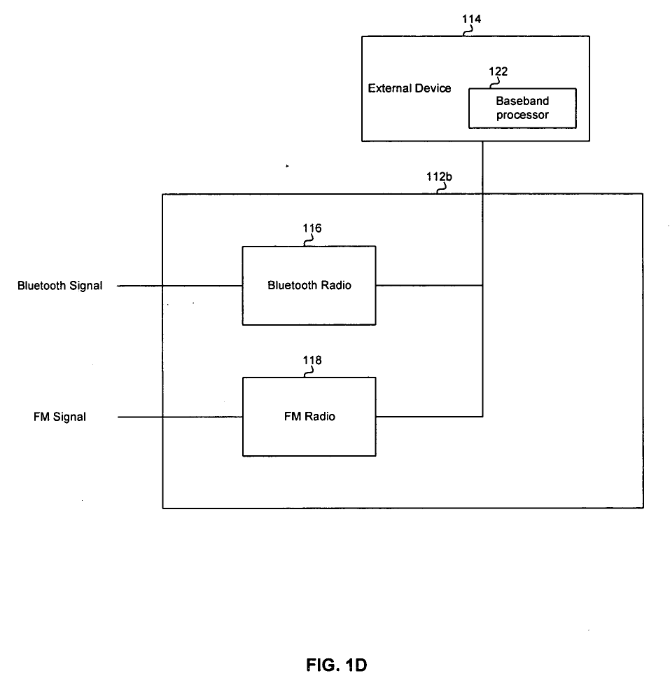

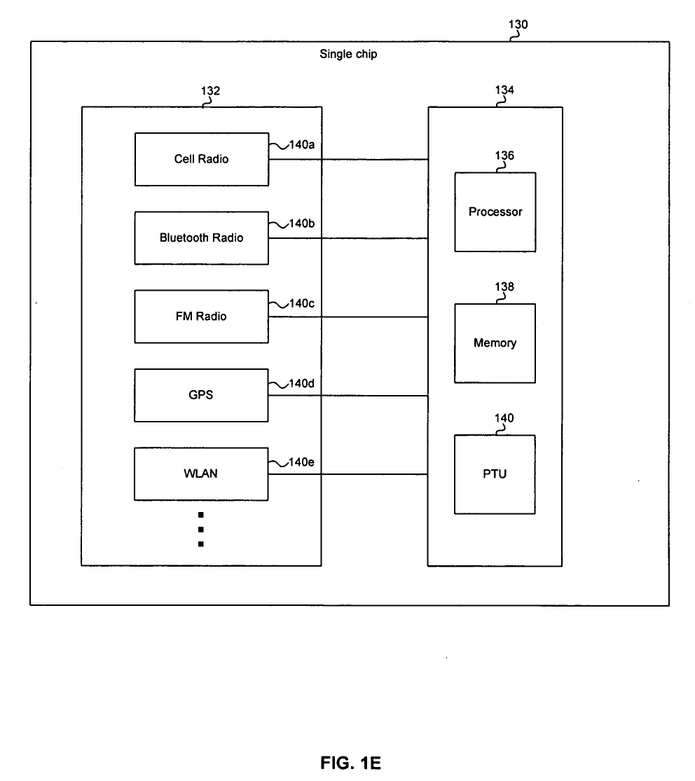

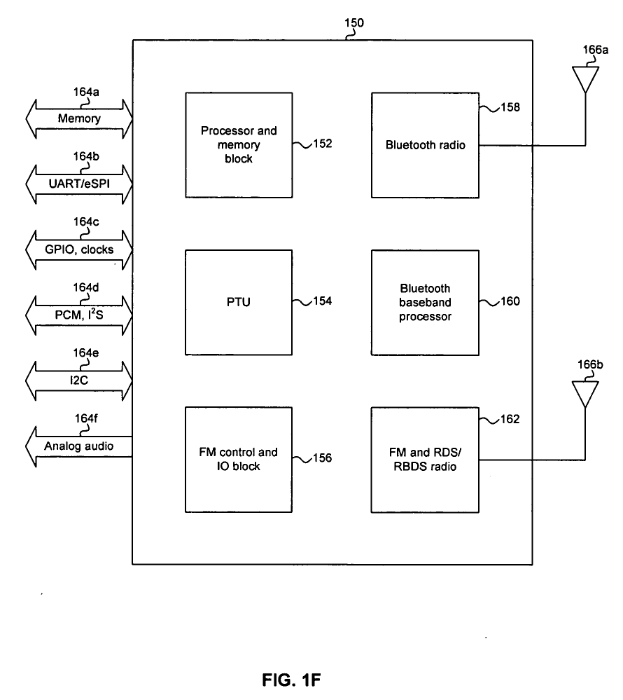

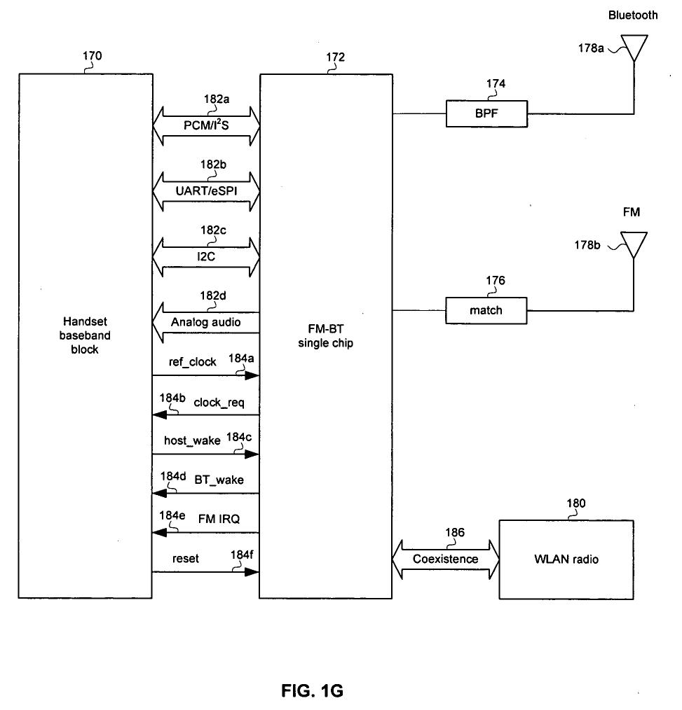

FIG. 1A is a block diagram of an exemplary FM transmitter that communicates with handlheld devices that utilize a single chip with integrated Bluetooth and FM radios, in accordance with an embodiment of the invention. Referring to FIG. 1A, there is shown an FM transmitter 102, a cellular phone 104a, a smart phone 104b, a computer 104c, and an exemplary FM and Bluetooth-equipped device 104d. The FM transmitter 102 may be implemented as part of a radio station or other broadcasting device, for example. Each of the cellular phone 104a, the smart phone 104b, the computer 104c, and the exemplary FM and Bluetooth-equipped device 104d may comprise a single chip 106 with integrated Bluetooth and FM radios for supporting FM and Bluetooth data communications. The FM transmitter 102 may enable communication of FM audio data to the devices shown in FIG. 1A by utilizing the single chip 106. Each of the devices in FIG. 1A may comprise and/or may be communicatively coupled to a listening device 108 such as a speaker, a headset, or an earphone, for example.

The cellular phone 104a may be enabled to receive an FM transmission signal from the FM transmitter 102. The user of the cellular phone 104a may then listen to the transmission via the listening device 108. The cellular phone 104a may comprise a “one-touch” programming feature that enables pulling up specifically desired broadcasts, like weather, sports, stock quotes, or news, for example. The smart phone 104b may be enabled to receive an FM transmission signal from the FM transmitter 102. The user of the smart phone 104b may then listen to the transmission via the listening device 108.

The computer 104c may be a desktop, laptop, notebook, tablet, and a PDA, for example. The computer 104c may be enabled to receive an FM transmission signal from the FM transmitter 102. The user of the computer 104c may then listen to the transmission via the listening device 108. The computer 104c may comprise software menus that configure listening options and enable quick access to favorite options, for example. In one embodiment of the invention, the computer 104c may utilize an atomic clock FM signal for precise timing applications, such as scientific applications, for example. While a cellular phone, a smart phone, computing devices, and other devices have been shown in FIG. 1A, the single chip 106 may be utilized in a plurality of other devices and/or systems that receive and use Bluetooth and/or FM signals. In one embodiment of the invention, the single chip Bluetooth and FM radio may be utilized in a system comprising a WLAN radio. The U.S. application Ser. No. ______ (Attorney Docket No. 17116US02), filed on even date herewith, discloses a method and system comprising a single chip Bluetooth and FM radio integrated with a wireless LAN radio, and is hereby incorporated herein by reference in its entirety.

FIG. 1B is a block diagram of an exemplary FM receiver that communicates with handheld devices that utilize a single chip with integrated Bluetooth and FM radios, in accordance with an embodiment of the invention. Referring to FIG. 1B, there is shown an FM receiver 110, the cellular phone 104a, the smart phone 104b, the computer 104c, and the exemplary FM and Bluetooth-equipped device 104d. In this regard, the FM receiver 110 may comprise and/or may be communicatively coupled to a listening device 108. A device equipped with the Bluetooth and FM transceivers, such as the single chip 106, may be able to broadcast its respective signal to a “deadband” of an FM receiver for use by the associated audio system. For example, a cellphone or a smart phone, such as the cellular phone 104a and the smart phone 104b, may transmit a telephone call for listening over the audio system of an automobile, via usage of a deadband area of the car's FM stereo system. One advantage may be the universal ability to use this feature with all automobiles equipped simply with an FM radio with few, if any, other external FM transmission devices or connections being required.

In another example, a computer, such as the computer 104c, may comprise an MP3 player or another digital music format player and may broadcast a signal to the deadband of an FM receiver in a home stereo system. The music on the computer may then be listened to on a standard FM receiver with few, if any, other external FM transmission devices or connections. While a cellular phone, a smart phone, and computing devices have been shown, a single chip that combines a Bluetooth and FM transceiver and/or receiver may be utilized in a plurality of other devices and/or systems that receive and use an FM signal.

FIG. 1C is a block diagram of an exemplary single chip with integrated Bluetooth and FM radios that supports FM processing and an external device that supports Bluetooth processing, in accordance with an embodiment of the invention. Referring to FIG. 1C, there is shown a single chip 112a that supports Bluetooth and FM radio operations and an external device 114. The single chip 112a may comprise an integrated Bluetooth radio 116, an integrated FM radio 118, and an integrated processor 120. The Bluetooth radio 116 may comprise suitable logic, circuitry, and/or code that enable Bluetooth signal communication via the single chip 112a. In this regard, the Bluetooth radio 116 may support audio signals or communication. The FM radio may comprise suitable logic, circuitry, and/or code that enable FM signal communication via the single chip 112a.

The integrated processor 120 may comprise suitable logic, circuitry, and/or code that may enable processing of the FM data received by the FM radio 118. Moreover, the integrated processor 120 may enable processing of FM data to be transmitted by the FM radio 118 when the FM radio 118 comprises transmission capabilities. The external device 114 may comprise a baseband processor 122. The baseband processor 122 may comprise suitable logic, circuitry, and/or code that may enable processing of Bluetooth data received by the Bluetooth radio 116. Moreover, the baseband processor 122 may enable processing of Bluetooth data to be transmitted by the Bluetooth radio 116. In this regard, the Bluetooth radio 116 may communicate with the baseband processor 122 via the external device 114. The Bluetooth radio 116 may communicate with the integrated processor 120.

FIG. 1D is a block diagram of an exemplary single chip with integrated Bluetooth and FM radios and an external device that supports Bluetooth and FM processing, in accordance with an embodiment of the invention. Referring to FIG. 1D, there is shown a single chip 112b that supports Bluetooth and FM radio operations and an external device 114. The single chip 112b may comprise the Bluetooth radio 116 and the FM radio 118. The Bluetooth radio 116 and/or the FM radio 118 may be integrated into the single chip 112b. The external device 114 may comprise a baseband processor 122. The baseband processor 122 may comprise suitable logic, circuitry, and/or code that may enable processing of Bluetooth data received by the Bluetooth radio 116 and/or processing of Bluetooth data to be transmitted by the Bluetooth radio 116. In this regard, the Bluetooth radio 116 may communicate with the baseband processor 122 via the external device 114. Moreover, the baseband processor 122 may comprise suitable logic, circuitry, and/or code that may enable processing of the FM data received by the FM radio 118. The baseband processor 122 may enable processing FM data to be transmitted by the FM radio 118 when the FM radio 118 comprises transmission capabilities. In this regard, the FM radio 118 may communicate with the baseband processor 122 via the external device 114.

FIG. 1E is a block diagram of an exemplary single chip with multiple integrated radios that supports radio data processing, in accordance with an embodiment of the invention. Referring to FIG. 1E, there is shown a single chip 130 that may comprise a radio portion 132 and a processing portion 134. The radio portion 132 may comprise a plurality of integrated radios. For example, the radio portion 132 may comprise a cell radio 140a that supports cellular communications, a Bluetooth radio 140b that supports Bluetooth communications, an FM radio 140c that supports FM communications, a global positioning system (GPS) 140d that supports GPS communications, and/or a wireless local area network (WLAN) 140e that supports communications based on the IEEE 802.11 standards.

The processing portion 134 may comprise at least one processor 136, a memory 138, and a peripheral transport unit (PTU) 140. The processor 136 may comprise suitable logic, circuitry, and/or code that enable processing of data received from the radio portion 132. In this regard, each of the integrated radios may communicate with the processing portion 134. In some instances, the integrated radios may communicate with the processing portion 134 via a common bus, for example. The memory 138 may comprise suitable logic, circuitry, and/or code that enable storage of data that may be utilized by the processor 136. In this regard, the memory 138 may store at least a portion of the data received by at least one of the integrated radios in the radio portion 132. Moreover, the memory 138 may store at least a portion of the data that may be transmitted by at least one of the integrated radios in the radio portion 132. The PTU 140 may comprise suitable logic, circuitry, and/or code that may enable interfacing data in the single chip 130 with other devices that may be communicatively coupled to the single chip 130. In this regard, the PTU 140 may support analog and/or digital interfaces.

FIG. 1F is a block diagram of an exemplary single chip with integrated Bluetooth and FM radios that supports multiple interfaces, in accordance with an embodiment of the invention. Referring to FIG. 1F, there is shown a single chip 150 that supports Bluetooth and FM radio communications. The single chip 150 may comprise a processor and memory block 152, a PTU 154, an FM control and input-output (IO) block 156, a Bluetooth radio 158, a Bluetooth baseband processor 160, and an FM and radio data system (RDS) and radio broadcast data system (RDBS) radio 162. A first antenna or antenna system 166a may be communicatively coupled to the Bluetooth radio 158. A second antenna or antenna system 166b may be communicatively coupled to the FM and RDS/RBDS radio 162.

The processor and memory block 152 may comprise suitable logic, circuitry, and/or code that may enable control, management, data processing operations, and/or data storage operations, for example. The PTU 154 may comprise suitable logic, circuitry, and/or code that may enable interfacing the single chip 150 with external devices. The FM control and IO block 156 may comprise suitable logic, circuitry, and/or code that may enable control of at least a portion of the FM and RDS/RBDS radio 162. The Bluetooth radio 158 may comprise suitable logic, circuitry, and/or code that may enable Bluetooth communications via the first antenna 166a. The FM and RDS/RBDS radio 162 may comprise suitable logic, circuitry, and/or code that may enable FM, RDS, and/or RBDS data communication via the second antenna 166b. The Bluetooth baseband processor 160 may comprise suitable logic, circuitry, and/or code that may enable processing of baseband data received from the Bluetooth radio 158 or baseband data to be transmitted by the Bluetooth radio 158.

The PTU 154 may support a plurality of interfaces. For example, the PTU 154 may support an external memory interface 164a, a universal asynchronous receiver transmitter (UART) and/or enhanced serial peripheral interface (eSPI) interface 164b, a general purpose input/output (GPIO) and/or clocks interface 164c, a pulse-code modulation (PCM) and/or an inter-IC sound (I²S) interface 164d, an inter-integrated circuit (I²C) bus interface 164e, and/or an audio interface 164f.

FIG. 1G is a block diagram of an exemplary single chip with integrated Bluetooth and FM radios that supports interfacing with a handset baseband device and a coexistent wireless LAN (WLAN) radio, in accordance with an embodiment of the invention. Referring to FIG. 1G, there is shown a single chip 172, a handset baseband block 170, a band pass filter 174, a first antenna or antenna system 178a, a matching circuit 176, a second antenna or antenna filter 178b, and a WLAN radio 180. The single chip 172 may be substantially similar to the single chip 150. In this instance, the single chip 172 may comprise suitable logic, circuitry, and/or code that may enable coexistent operation with the WLAN radio 180 via the coexistence interface 186.

The single chip 172 may communicate Bluetooth data via the BPF 174 and the first antenna 178a. The single chip 172 may also communicate FM data via the matching circuit 176 and the second antenna 178b. The single chip 172 may coordinate Bluetooth data communication in the presence of WLAN channels by communicating with the WLAN radio 180 via the coexistence interface 186.

The single chip 172 may transfer data to the handset baseband block 170 via at least one interface, such as a PCM/I²S interface 182a, a UART/eSPI interface 182b, a I²C interface 182c, and/or and analog audio interface 182d. The single chip 172 and the handset baseband block 170 may also communicate via at least one control signal. For example, the handset baseband block 170 may generate a clock signal, ref_clock, 184a, a wake signal, host_wake 184c, and/or a reset signal 184f that may be transferred to the single chip 172. Similarly, the single chip 172 may generate a clock request signal, clock_req, 184b, a Bluetooth wake signal, BT_wake, 184d, and/or an FM interrupt request signal, FM IRQ, 184e that may be transferred to the handset baseband block 170. The handset baseband block 170 may comprise suitable logic, circuitry, and/or code that may enable processing of at least a portion of the data received from the single chip 172 and/or data to be transferred to the single chip 172. In this regard, the handset baseband block 170 may transfer data to the single chip 172 via at least one interface.

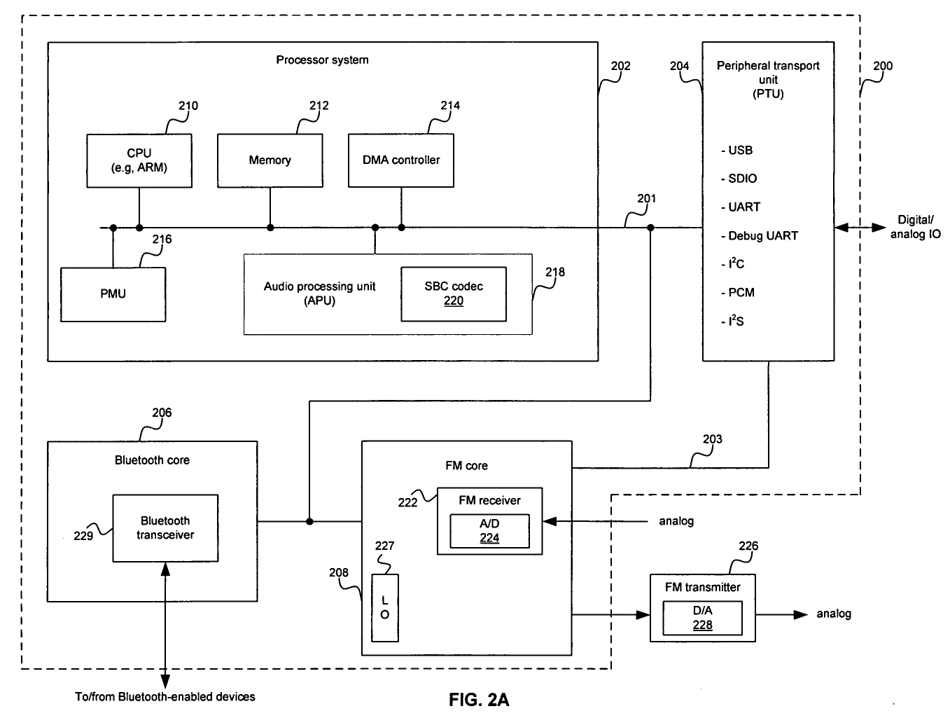

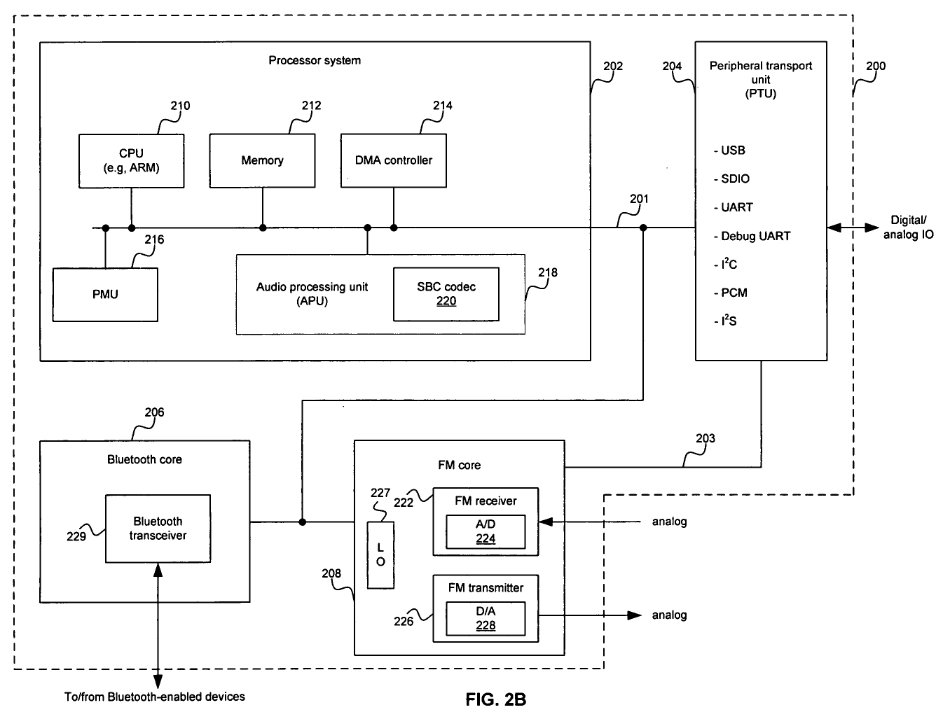

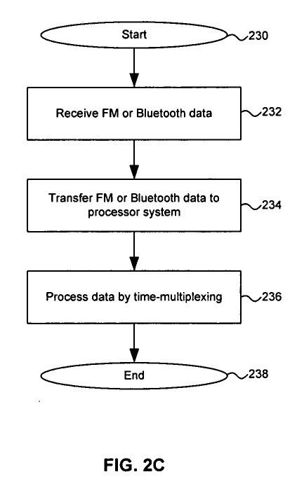

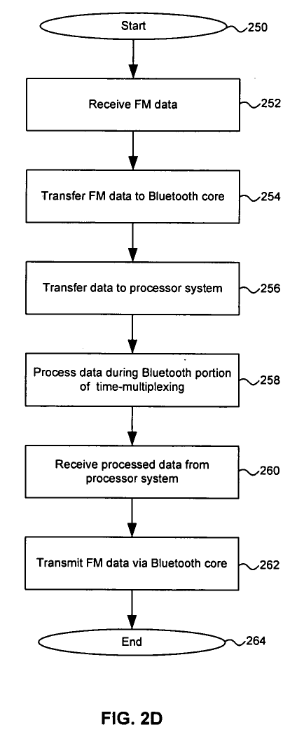

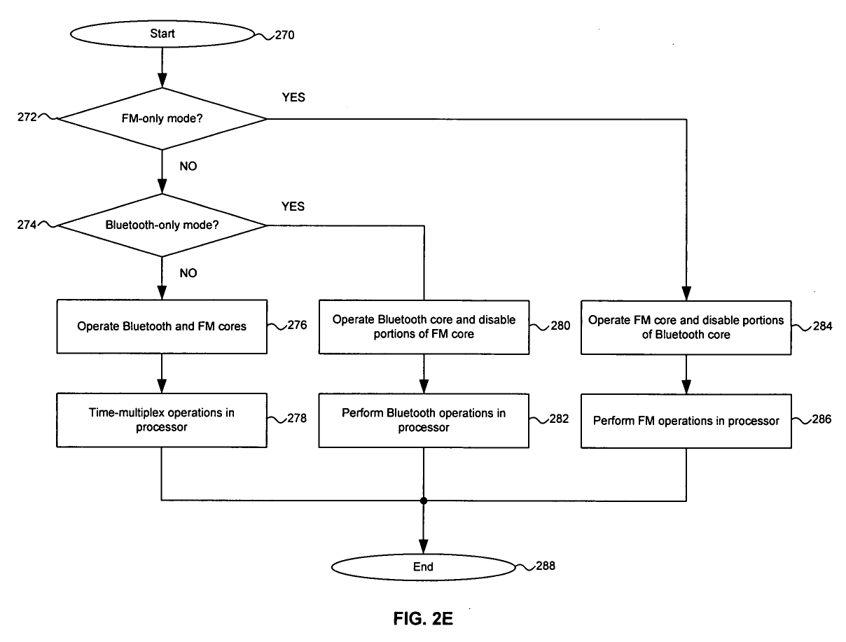

FIG. 2A is a block diagram of an exemplary single chip that supports Bluetooth and FM operations with an external FM transmitter, in accordance with an embodiment of the invention. Referring to FIG. 2A, there is shown a single chip 200 that may comprise a processor system 202, a peripheral transport unit (PTU) 204, a Bluetooth core 206, a frequency modulation (FM) core 208, and a common bus 201. An FM transmitter 226 may be an external device to the single chip 200 and may be communicatively coupled to the single chip 200 via the FM core 208, for example. The FM transmitter 226 may be a separate integrated circuit (IC), for example.

The processor system 202 may comprise a central processing unit (CPU) 210, a memory 212, a direct memory access (DMA) controller 214, a power management unit (PMU) 216, and an audio processing unit (APU) 218. The APU 218 may comprise a subband coding (SBC) codec 220. At least a portion of the components of the processor system 202 may be communicatively coupled via the common bus 201.

The CPU 210 may comprise suitable logic, circuitry, and/or code that may enable control and/or management operations in the single chip 200. In this regard, the CPU 210 may communicate control and/or management operations to the Bluetooth core 206, the FM core 208, and/or the PTU 204 via a set of register locations specified in a memory map. Moreover, the CPU 210 may be utilized to process data received by the single chip 200 and/or to process data to be transmitted by the single chip 200. The CPU 210 may enable processing of data received via the Bluetooth core 206, via the FM core 208, and/or via the PTU 204. For example, the CPU 210 may enable processing of A2DP data and may then transfer the processed A2DP data to other components of the single chip 200 via the common bus 201. In this regard, the CPU may utilize the SBC codec 220 in the APU 218 to encode and/or decode A2DP data, for example. The CPU 210 may enable processing of data to be transmitted via Bluetooth core 206, via the FM core 208, and/or via the PTU 204. The CPU 210 may be, for example, an ARM processor or another embedded processor core that may be utilized in the implementation of system-on-chip (SOC) architectures.

The CPU 210 may time multiplex Bluetooth data processing operations and FM data processing operations. In this regard, the CPU 210 may perform each operation by utilizing a native clock, that is, Bluetooth data processing based on a Bluetooth clock and FM data processing based on an FM clock. The Bluetooth clock and the FM clock may be distinct and may not interact. The CPU 210 may gate the FM clock and the Bluetooth clock and may select the appropriate clock in accordance with the time multiplexing scheduling or arrangement. When he CPU 210 switches between Bluetooth operations and FM operations, at least certain states associated with the Bluetooth operations or with the FM operations may be retained until the CPU 210 switches back.

For example, in the case where the Bluetooth function is not active and is not expected to be active for some time, the CPU 210 may run on a clock derived from the FM core 208. This may eliminate the need to bring in a separate high-speed clock when one is already available in the FM core 208. In the case where the Bluetooth core 206 may be active, for example when the Bluetooth is in a power-saving mode that requires it to be active periodically, the processor may chose to use a clock derived separately from the FM core 208. The clock may be derived directly from a crystal or oscillator input to the Bluetooth core 206, or from a phase locked loop (PLL) in the Bluetooth core 206. While this clocking scheme may provide certain flexibility in the processing operations performed by the CPU 210 in the single chip 200, other clocking schemes may also be implemented.

The CPU 210 may also enable configuration of data routes to and/or from the FM core 208. For example, the CPU 210 may configure the FM core 208 so that data may be routed via an I²S interface or a PCM interface in the PTU 204 to the analog ports communicatively coupled to the PTU 204.

The CPU 210 may enable tuning, such as flexible tuning, and/or searching operations in Bluetooth and/or FM communication by controlling at least a portion of the Bluetooth core 206 and/or the FM core 208. For example, the CPU 210 may generate at least one signal that tunes the FM core 208 to a certain frequency to determine whether there is a station at that frequency. When a station is found, the CPU 210 may configure a path for the audio signal to be processed in the single chip 200. When a station is not found, the CPU 210 may generate at least one additional signal that tunes the FM core 208 to a different frequency to determine whether a station may be found at the new frequency.

Searching algorithms may enable the FM core 208 to scan up or down in frequency from a presently tuned channel and stop on the next channel with received signal strength indicator (RSSI) above a threshold. The search algorithm may be able to distinguish image channels. The choice of the IF frequency during search is such that an image channel may have a nominal frequency error of 50 kHz, which may be used to distinguish the image channel from the “on” channel. The search algorithm may also be able to determine if a high side or a low side injection provides better receive performance, thereby allowing for a signal quality metric to be developed for this purpose. One possibility to be investigated is monitoring the high frequency RSSI relative to the total RSSI. The IF may be chosen so that with the timing accuracy that a receiver may be enabled to provide, the image channels may comprise a frequency error that is sufficiently large to differentiate the image channels from the on channel.

The CPU 210 may enable a host controller interface (HCI) in Bluetooth. In this regard, the HCI provides a command interface to the baseband controller and link manager, and access to hardware status and control registers. The HCI may provide a method of accessing the Bluetooth baseband capabilities that may be supported by the CPU 210.

The memory 212 may comprise suitable logic, circuitry, and/or code that may enable data storage. In this regard, the memory 212 may be utilized to store data that may be utilized by the processor system 202 to control and/or manage the operations of the single chip 200. The memory 212 may also be utilized to store data received by the single chip 200 via the PTU 204 and/or via the FM core 208. Similarly, the memory 212 may be utilized to store data to be transmitted by the single chip 200 via the PTU 204 and/or via the FM core 208. The DMA controller 214 may comprise suitable logic, circuitry, and/or code that may enable transfer of data directly to and from the memory 212 via the common bus 201 without involving the operations of the CPU 210.

The PTU 204 may comprise suitable logic, circuitry, and/or code that may enable communication to and from the single chip 200 via a plurality of communication interfaces. In some instances, the PTU 204 may be implemented outside the single chip 200, for example. The PTU 204 may support analog and/or digital communication with at least one port. For example, the PTU 204 may support at least one universal series bus (USB) interface that may be utilized for Bluetooth data communication, at least one secure digital input/output (SDIO) interface that may also be utilized for Bluetooth data communication, at least one universal asynchronous receiver transmitter (UART) interface that may also be utilized for Bluetooth data communication, and at least one I²C bus interface that may be utilized for FM control and/or FM and RDS/RBDS data communication. The PTU 204 may also support at least one PCM interface that may be utilized for Bluetooth data communication and/or FM data communication, for example.

The PTU 204 may also support at least one inter-IC sound (I²S) interface, for example. The I²S interface may be utilized to send high fidelity FM digital signals to the CPU 210 for processing, for example. In this regard, the I²S interface in the PTU 204 may receive data from the FM core 208 via a bus 203, for example. Moreover, the I²S interface may be utilized to transfer high fidelity audio in Bluetooth. For example, in the A2DP specification there is support for wideband speech that utilizes 16 kHz of audio. In this regard, the I²S interface may be utilized for Bluetooth high fidelity data communication and/or FM high fidelity data communication. The I²S interface may be a bidirectional interface and may be utilized to support bidirectional communication between the PTU 204 and the FM core 208 via the bus 203. The I²S interface may be utilized to send and receive FM data from external devices such as coder/decoders (CODECs) and/or other devices that may further process the I²S data for transmission, such as local transmission to speakers and/or headsets and/or remote transmission over a cellular network, for example.

The Bluetooth core 206 may comprise suitable logic, circuitry, and/or code that may enable reception and/or transmission of Bluetooth data. The Bluetooth core 206 may comprise a Bluetooth transceiver 229 that may perform reception and/or transmission of Bluetooth data. In this regard, the Bluetooth core 206 may support amplification, filtering, modulation, and/or demodulation operations, for example. The Bluetooth core 206 may enable data to be transferred from and/or to the processor system 202, the PTU 204, and/or the FM core 208 via the common bus 201, for example.

The FM core 208 may comprise suitable logic, circuitry, and/or code that may enable reception and/or transmission of FM data. The FM core 208 may comprise an FM receiver 222 and a local oscillator (LO) 227. The FM receiver 222 may comprise an analog-to-digital (A/D) converter 224. The FM receiver 222 may support amplification, filtering, and/or demodulation operations, for example. The LO 227 may be utilized to generate a reference signal that may be utilized by the FM core 208 for performing analog and/or digital operations. The FM core 206 may enable data to be transferred from and/or to the processor system 202, the PTU 204, and/or the Bluetooth core 206 via the common bus 201, for example. Moreover, the FM core 208 may receive analog FM data via the FM receiver 222. The A/D converter 224 in the FM receiver 222 may be utilized to convert the analog FM data to digital FM data to enable processing by the FM core 208. The FM core 208 may also enable the transfer of digital FM data to the FM transmitter 226. The FM transmitter 226 may comprise a digital-to-analog (D/A) converter 228 that may be utilized to convert digital FM data to analog FM data to enable transmission by the FM transmitter 226. Data received by the FM core 208 may be routed out of the FM core 208 in digital format via the common bus 201 and/or in analog format via the bus 203 to the I²S interface in the PTU 204, for example.

The FM core 208 may enable radio transmission and/or reception at various frequencies, such as, 400 MHz, 900 MHz, 2.4 GHz and/or 5.8 GHz, for example. The FM core 208 may also support operations at the standard FM band comprising a range of about 76 MHz to 108 MHz, for example.

The FM core 208 may also enable reception of RDS data and/or RBDS data for in-vehicle radio receivers. In this regard, the FM core 208 may enable filtering, amplification, and/or demodulation of the received RDS/RBDS data. The RDS/RBDS data may comprise, for example, a traffic message channel (TMC) that provides traffic information that may be communicated and/or displayed to an in-vehicle user.

Digital circuitry within the FM core 208 may be operated based on a clock signal generated by dividing down a signal generated by the LO 227. The LO 227 may be programmable in accordance with the various channels that may be received by the FM core 208 and the divide ratio may be varied in order to maintain the digital clock signal close to a nominal value.

The RDS/RBDS data may be buffered in the memory 212 in the processor system 202. The RDS/RBDS data may be transferred from the memory 212 via the I²C interface when the CPU 210 is in a sleep or stand-by mode. For example, the FM core 208 may post RDS data into a buffer in the memory 212 until a certain level is reached and an interrupt is generated to wake up the CPU 210 to process the RDS/RBDS data. When the CPU 210 is not in a sleep mode, the RDS data may be transferred to the memory 212 via the common bus 201, for example.

Moreover, the RDS/RBDS data received via the FM core 208 may be transferred to any of the ports communicatively coupled to the PTU 204 via the HCI scheme supported by the single chip 200, for example. The RDS/RBDS data may also be transferred to the Bluetooth core 206 for communication to Bluetooth-enabled devices.

In one exemplary embodiment of the invention, the single chip 200 may receive FM audio data via the FM core 208 and may transfer the received data to the Bluetooth core 206 via the common bus 201. The Bluetooth core 206 may transfer the data to the processor system 202 to be processed. In this regard, the SBC codec 220 in the APU 218 may perform SBC coding or other A2DP compliant audio coding for transportation of the FM data over a Bluetooth A2DP link. The processor system 202 may also enable performing continuous variable slope delta (CVSD) modulation, log pulse code modulation (Log PCM), and/or other Bluetooth compliant voice coding for transportation of FM data on Bluetooth synchronous connection-oriented (SCO) or extended SCO (eSCO) links. The Bluetooth-encoded FM audio data may be transferred to the Bluetooth core 206, from which it may be communicated to another device that supports the Bluetooth protocol. The CPU 210 may be utilized to control and/or manage the various data transfers and/or data processing operations in the single chip 200 to support the transmission of FM audio data via the Bluetooth protocol.

Moreover, when Bluetooth data is received, such as A2DP, SCO, eSCO, and/or MP3, for example, the Bluetooth core 206 may transfer the received data to the processor system 202 via the common bus 201. At the processor system 202, the SBC codec 220 may decode the Bluetooth data and may transfer the decoded data to the FM core 208 via the common bus 201. The FM core 208 may transfer the data to the FM transmitter 226 for communication to an FM receiver in another device.

In another exemplary embodiment of the invention, the single chip 200 may operate in a plurality of modes. For example, the single chip 200 may operate in one of an FM-only mode, a Bluetooth-only mode, and an FM-Bluetooth mode. For the FM-only mode, the single chip 200 may operate with a lower power active state than in the Bluetooth-only mode or the FM-Bluetooth mode because FM operation in certain devices may have a limited source of power. In this regard, during the FM-only mode, at least a portion of the operation of the Bluetooth core 206 may be disabled to reduce the amount of power used by the single chip 200. Moreover, at least a portion of the processor system 202, such as the CPU 210, for example, may operate based on a divided down clock from a phase locked-loop (PLL) in the FM core 208. In this regard, the PLL in the FM core 208 may utilize the LO 227, for example.

Moreover, because the code necessary to perform certain FM operations, such as tuning and/or searching, for example, may only require the execution of a few instructions in between time intervals of, for example, 10 ms, the CPU 210 may be placed on a stand-by or sleep mode to reduce power consumption until the next set of instructions is to be executed. In this regard, each set of instructions in the FM operations code may be referred to as a fragment or atomic sequence. The fragments may be selected or partitioned in a very structured manner to optimize the power consumption of the single chip 200 during FM-only mode operation. In some instances, fragmentation may also be implemented in the FM-Bluetooth mode to enable the CPU 210 to provide more processing power to Bluetooth operations when the FM core 208 is carrying out tuning and/or searching operations, for example.

FIG. 2B is a block diagram of an exemplary single chip that supports Bluetooth and FM operations with an integrated FM transmitter, in accordance with an embodiment of the invention. Referring to FIG. 2B, there is shown the single chip 200 as described in FIG. 2A with the FM transmitter 226 integrated into the FM core 208. In this regard, the FM core 208 may support FM reception and/or transmission of FM data. The FM transmitter 226 may utilize signals generated based on the reference signal generated by the LO 227. The FM core 208 may enable transmission of data received via the PTU 204 and/or the Bluetooth core 206, for example. The exemplary implementation of the single chip 200 as described in FIG. 2B may support FM reception and/or transmission and Bluetooth reception and/or transmission.

FIG. 2C is a flow diagram that illustrates exemplary steps for processing received data in a single chip with integrated Bluetooth and FM radios, in accordance with an embodiment of the invention. Referring to FIGS. 2A and 2C, in step 232, after start step 230, the FM core 208 or the Bluetooth core 206 may receive data. For example, the FM core 208 may receive FM data via the FM receiver 222 and the Bluetooth core 206 may receive Bluetooth data via the Bluetooth transceiver 229. In step 234, the received data may be transferred to the processor system 202 via the common bus 201 for processing. The received data may be transferred to the memory 212 by the DMA controller 214, for example. In some instances, the processor system 202 may then transfer the data to the PTU 204, for example. The received data may be transferred to the processing system 202 in accordance with the time multiplexing schedule or arrangement provided by the processing system 202. In step 236, the processor system 202 may time multiplex the processing of FM data and the processing of Bluetooth data. For example, when Bluetooth data is being processed, FM data may not be transferred to the processing system 202 or may be transferred and stored in the memory 212 until FM processing is enabled. When the processing system 202 has completed processing the Bluetooth data, the FM data may be transferred to the processing system 202 for FM processing. Similarly, when FM data is being processed, Bluetooth data may not be transferred to the processing system 202 or may be transferred and stored in the memory 212 until Bluetooth processing is enabled. When the processing system 202 has completed processing the FM data, the Bluetooth data may be transferred to the processing system 202 for Bluetooth processing. After step 236, the process may proceed to end step 238.

FIG. 2D is a flow diagram that illustrates exemplary steps for processing FM data via the Bluetooth core in a single chip with integrated Bluetooth and FM radios, in accordance with an embodiment of the invention. Referring to FIGS. 2A and 2D, after start step 250, in step 252, the FM core 208 may receive FM data via the FM receiver 222. In step 254, the FM core 208 may transfer the FM data to the Bluetooth core 206 via the common bus 201. In step 256, the Bluetooth core 206 may transfer the FM data received from the FM core 208 to the processor system 202 via the common bus 201. In step 258, the processor system 202 may perform Bluetooth processing operations, such as encoding for example, to the FM data received from the Bluetooth core 206. In step 260, the Bluetooth core 206 may receive the processed FM data. In step 262, the Bluetooth core 206 may transfer the processed FM data to at least one Bluetooth-enable device via the Bluetooth transceiver 229.

An illustrative instance where the exemplary steps described in FIG. 2D may occur is when a handset is enabled to receive FM data and the handset may be enabled to operate with a Bluetooth headset. In this regard, the handset may receive the FM audio signal via the FM core 208 and may process the received signal for transfer to the headset via the Bluetooth core 206.

FIG. 2E is a flow diagram that illustrates exemplary steps for configuring a single chip with integrated Bluetooth and FM radios based on the mode of operation, in accordance with an embodiment of the invention. Referring to FIG. 2E, after start step 270, in step 272, when a single chip with integrated Bluetooth and FM radios operates in an FM-only mode, the process may proceed to step 284. In step 284, the FM core 208 may be configured for operation and at least portions of the Bluetooth core 206 may be disabled. In step 286, FM data received and/or FM data to be transmitted may be processed in the processor system 202 without need for time multiplexing.

Returning to step 272, when the single chip is not operating in the FM-only mode, the process may proceed to step 274. In step 274, when the single chip is operating in the Bluetooth-only mode, the process may proceed to step 280. In step 280, the Bluetooth core 206 may be configured for operation and at least portions of the FM core 208 may be disabled. In step 282, Bluetooth data received and/or Bluetooth data to be transmitted may be processed in the processor system 202 without need for time multiplexing.

Returning to step 274, when the single chip is not operating in the Bluetooth-only mode, the process may proceed to step 276. In step 276, the Bluetooth core 206 and the FM core 208 may be configured for operation. In step 278, Bluetooth data and/or FM data may be processed in the processor system 202 in accordance with time multiplexing schedule or arrangement.

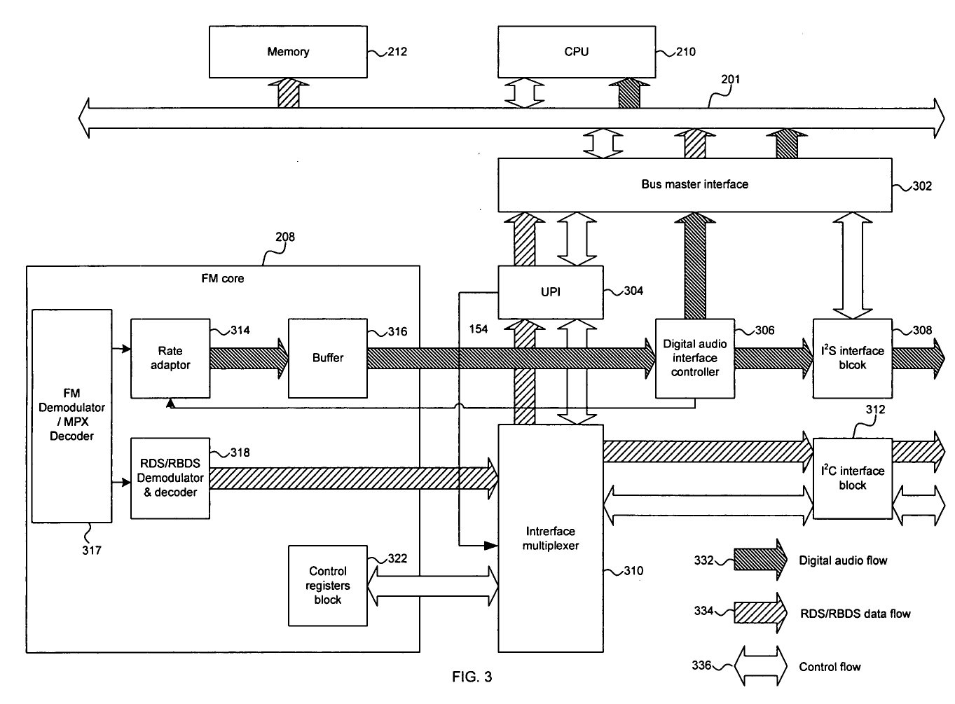

FIG. 3 is a block diagram of an exemplary FM core and PTU for processing RDS and digital audio data, in accordance with an embodiment of the invention. Referring to FIG. 3, there is shown a more detailed portion of the single chip 200 described in FIGS. 2A-2B. The portion of the single chip 200 shown in FIG. 3 comprises the FM core 208, the memory 212, the CPU 210, and the common bus 201. Also shown are portions of the PTU 204 comprising an interface multiplexer 310, a universal peripheral interface (UPI) 304, a bus master interface 302, a digital audio interface controller 306, an I²S interface block 308, and an I²C interface block 312. The FM core 208 may comprise an FM/MPX demodulator and decoder 317, a rate adaptor 314, a buffer 316, an RDS/RBDS decoder 318, and a control registers block 322. Narrowly spaced hashed arrows as illustrated by the flow arrow 332 show the flow of digital audio data. Broadly spaced hashed arrows as illustrated by the flow arrow 334 show the flow of RDS/RBDS data. Clear or blank arrows, as illustrated by the dual flow arrow 336, show the flow of control data.

The FM/MPX demodulator and decoder 317 may comprise suitable logic, circuitry, and/or code that may enable processing of FM and/or FM MPX stereo audio, for example. The FM/MPX demodulator and decoder 317 may demodulate and/or decode audio signals that may be transferred to the rate adaptor 314. The FM/MPX demodulator and decoder 317 may demodulate and/or decode signals that may be transferred to the RDS/RBDS demodulator and decoder 318. The rate adaptor 314 may comprise suitable logic, circuitry, and/or code that may enable controlling the rate of the FM data received from the FM/MPX demodulator and decoder 317. The rate adaptor 314 may adapt the output sampling rate of the audio paths to the sampling clock of the host device or the rate of a remote device when a digital audio interface is used to transport the FM data. An initial rough estimate of the adaptation fractional change may be made and the estimate may then refined by monitoring the ratio of reading and writing rates and/or by monitoring the level of the audio samples in the output buffer. The rate may be adjusted in a feedback manner such that the level of the output buffer is maintained. The rate adaptor 314 may receive a strobe or pull signal from the digital audio interface controller 306, for example. Audio FM data from the rate adaptor 314 may be transferred to the buffer 316.

The buffer 316 may comprise suitable logic, circuitry, and/or code that may enable storage of digital audio data. The buffer 316 may receive a strobe or pull signal from the digital audio interface controller 306, for example. The buffer 316 may transfer digital audio data to the digital audio interface controller 306. The digital audio interface controller 306 may comprise suitable logic, circuitry, and/or code that may enable the transfer of digital audio data to the bus master interface 302 and/or the I²S interface block 308. The I²S interface 308 may comprise suitable logic, circuitry, and/or code that may enable transfer of the digital audio data to at least one device communicatively coupled to the single chip. The I²S interface 308 may communicate control data with the bus master interface 302.

The RDS/RBDS demodulator and decoder 318 may comprise suitable logic, circuitry, and/or code that may enable processing of RDS/RBDS data from the FM/MPX demodulator and decoder 317. The RDS/RBDS demodulator and decoder 318 may provide further demodulation and/or decoding to data received from the FM/MPX demodulator and decoder 317. The RDS/RBDS decoder 318 may comprise suitable logic, circuitry, and/or code that may enable processing of RDS/RBDS data received by the FM core 208. The RDS/RBDS decoder 318 may have two phases to complete decoding of the data received by the FM core 208: an acquisition phase and a decoding phase. The RDS/RBDS decoder 318 may synchronize the received data during the acquisition phase, and decode the data during the decoding phase. The output of the RDS/RBDS decoder 318 may be transferred to the interface multiplexer 310. The interface multiplexer 310 may comprise suitable logic, circuitry, and/or code that may enable the transfer of RDS/RBDS data to the UPI 304 and/or the I²C interface block 312. In this regard, the UPI 304 may generate a signal that indicates to the interface multiplexer 310 the interface to select. The I²C interface 312 may comprise suitable logic, circuitry, and/or code that may enable transfer of the RDS/RBDS data to at least one device communicatively coupled to the single chip. The I²C interface 312 may also communicate control data between external devices to the single chip and the interface multiplexer 310. In this regard, the interface multiplexer 310 may communicate control data between the I²C interface 312, the UPI 304, and/or the control registers block 322 in the FM core 208. The control registers block 322 may comprise suitable logic, circuitry, and/or code that may enable the storage of register information that may be utilized to control and/or configure the operation of at least portions of the FM core 208.

The UPI 304 may comprise suitable logic, circuitry, and/or code that may enable the transfer of digital audio data to the bus master interface 302 from the interface multiplexer 310. The UPI 304 may also enable the communication of control data between the bus master interface 302 and the interface multiplexer 310. The bus master interface 302 may comprise suitable logic, circuitry, and/or code that may enable communication of control data, digital audio data, and/or RDS/RBDS data between the portions of the PTU 204 shown in FIG. 3 and the common bus 201. The bus master interface 302 may transfer digital audio data and/or RDS/RBDS data to the common bus 201. The RDS/RBDS data may be transferred to the memory 212, for example. In some instances, the RDS/RBDS data may be transferred to the memory 212 when the CPU 210 is in a stand-by or sleep mode. The bus master interface 302 may push RDS/RBDS data into a buffer in the memory 212 or may pull RDS/RBDS data from a buffer in the memory 212, for example. The digital audio data may be transferred to the CPU 210 for processing, for example. The CPU 210 may generate and/or receive control data that may be communicated with the PTU 204 and/or the FM core 208 via the common bus 201.

In one embodiment of the invention, the single chip with integrated FM and Bluetooth radios may implement a search algorithm that collects and stores data during scanning of the FM band. The single chip may determine whether there is music or speech in a detected channel. Moreover, the single chip may enable searching and finding 10 of the strongest stations, for example, and may rank them.

In another embodiment of the invention, the single chip with integrated FM and Bluetooth radios may implement a search algorithm where the searches may be done based on specific criteria such as type of station or type of music, for example. The single chip may characterize each of the stations found based on the search.

In another embodiment of the invention, the single chip with integrated FM and Bluetooth radios may enable turning OFF a voltage regulator to the FM radio when in BT-only mode or turning OFF voltage regulators to the Bluetooth radio and the FM radio when both Bluetooth and FM are not being used, for example. In another embodiment of the invention, the single chip with integrated FM and Bluetooth radios may enable extending the battery life in a handheld device by requiring that the single chip does not consume power until configured by the host. Moreover, there may not be a load on the system until the chip is powered down and/or the chip may not draw any current when powered down.

In another embodiment of the invention, the single chip with integrated FM and Bluetooth radios may enable a digital filter that may combine de-emphasis, bass, and/or treble. The digital filter may have a programmable audio bandwidth, for example. In another embodiment of the invention, the single chip with integrated FM and Bluetooth radios may enable a power amplifier dynamical bypass for Class 1 systems. In another embodiment of the invention, the single chip with integrated FM and Bluetooth radios may enable an antenna with an adjustable center frequency.

In another embodiment of the invention, the single chip with integrated FM and Bluetooth radios may enable Bluetooth coexistence with WLAN. In this regard, coexistence may be supported when radiation of energy is not greater than a certain threshold. In some cases, such threshold may be 90 dBm, for example. The coexistence may be implemented to minimize the amount of energy that flows from the Bluetooth radio to the WLAN radio, for example. In this regard, the single chip may utilize a guilty-by-association technique in order to identify WLAN interfering channels in the vicinity of a Bluetooth device. Because WLAN channels may deteriorate very rapidly in the presence of Bluetooth communication, the guilty-by-association technique may enable a fast determination or identification of which adaptive frequency hopping (AFH) channels to block in order to limit the effect of Bluetooth communication on WLAN channels. Channel measurement statistics may be collected in ‘bins’ of N MHz each where N=2, 3, 4, etc and condemn the entire bin as bad if any K of the channels in the bin was measured as bad. An example may be when K=1. Condemnation of the entire bin as bad, that is, guilty-by-association, may increase both the reliability as well as speed with a WLAN channels of contiguous 20˜22 MHz that may be blocked out in the AFH channel map. The use of techniques that modify the AFH channel map need not be limited to instances when a Bluetooth radio and an FM radio are integrated into a single chip. Modification of the AFH channel map may be applied to instances when Bluetooth applications are in coexistent operation with WLAN applications.

The WLAN interfering channels may be detected by utilizing channel measurement statistics such as received signal strength indicator (RSSI) energy measurements and/or packet error rate (PER) measurements. PER measurements may include missing a packet due to synchronization errors, cyclic redundancy check (CRC) errors in decoding the header, and/or CRC errors in decoding the payload, for example. These measurements may be performed during the Bluetooth frame duration (1.25 ms) on the current Bluetooth channel or on channels different from the current Bluetooth channel.

In another embodiment of the invention, the single chip with integrated FM and Bluetooth radios may enable a low noise FM phase-locked loop (PLL) that may minimize the 32 KHz clock noise and/or the large phase noise that may occur. In this regard, the FM PLL may utilize a narrow loop bandwidth, for example.

In another embodiment of the invention, the single chip with integrated FM and Bluetooth radios may disable at least a portion of the analog circuitry in the FM radio and/or the Bluetooth radio when performing digital processing. Disabling analog circuitry provides a reduction in the amount of power consumed by the single chip.

In another embodiment of the invention, the single chip with integrated FM and Bluetooth radios may be enabled to support high definition (HD) radio systems. In HD radio systems, the broadcasters may utilize digital signals to transmit existing analog AM and FM signals. In this regard, the analog AM and FM signals may be transmitted simultaneously and the use of digital channels may result in higher quality audio and a more robust signal. In first generation HD radio systems, services such as Main Program Service or Station Reference Service may be provided. Other services that may be supported for HD radio in the single chip may be requests for audio presentation of news, weather, entertainment, and/or stocks, for example. Additional services may comprise navigational products or applications, such as traffic information, for example, time-shifted listening, mobile commerce and advertisement, Internet-based broadcasts, and/or reading services for the visually impaired.

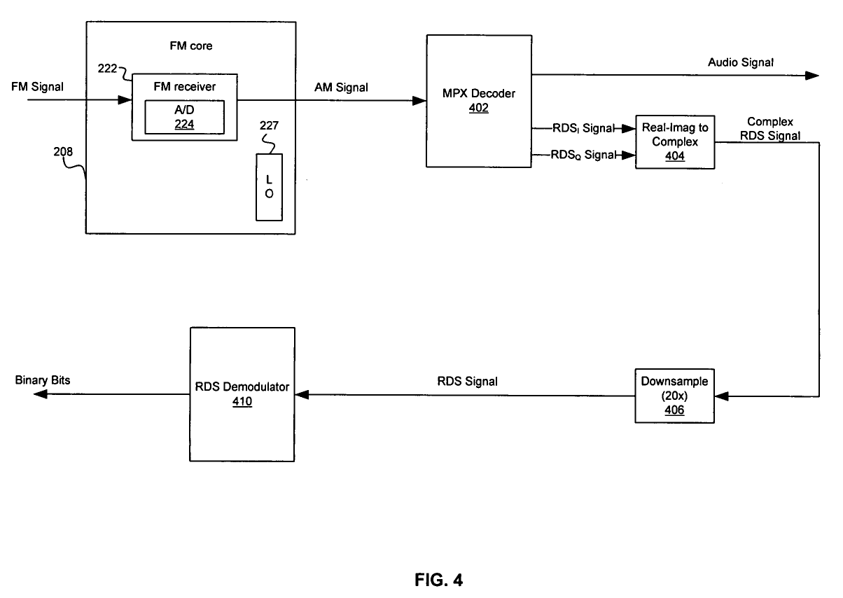

FIG. 4 is a block diagram of an exemplary system for RDS subcarrier decoding and demodulation of an RDS signal in a single chip integrated Bluetooth and FM transceiver, in accordance with an embodiment of the invention. Referring to FIG. 4, there is shown an FM core 208, a multiplex (MPX) decoder 402, a real signal component and imaginary signal component to signal conversion block 404, a downsample converter block 406, a high pass filter block 408, and an RDS demodulator 410. The FM core 208 may comprise an FM receiver 222 and a local oscillator (LO) 227. The FM receiver 222 may comprise an analog to digital converter 224.

FM core 208 may comprise suitable circuitry, logic, and/or code that may enable FM demodulation on a received FM signal. The result may be an AM signal, for example. MPX decoder 402 may comprise suitable circuitry, logic, and/or code that may enable processing of a received signal that comprises audio information and/or data. The MPX decoder 402 may generate an audio signal and a data signal. The data signal may comprise a RDS signal. The RDS signal may comprise an in-phase signal component, RDS_{I}, and a quadrature phase signal component, RDS_{Q}.

The real signal component and imaginary signal component to complex signal conversion block 404 may comprise suitable logic, circuitry, and/or code that may enable generation of a complex signal representation of a real signal component and an imaginary signal component. The real signal component and imaginary signal component to complex signal conversion block 404 may receive an in-phase signal component, RDS_{I}, and a quadrature phase signal component, RDS_{Q}. The real signal component and imaginary signal component to complex signal conversion block 404 may construct a complex RDS signal according to the following equation, for example:
RDS_{C}=RDS_{I}+i·RDS_{Q} (1)
where RDS_{C} may represent a complex representation of the RDS signal, and i may represent the square root of the quantity −1.

The downsample converter block 406 may comprise suitable circuitry, logic, and/or code that may be utilized to reduce a rate at which a signal is digitally sampled. For example, the downsample converter block 406 may receive a complex RDS signal that is digitally sampled every 1/Tₛₐₘₚ seconds. The downsample converter block 406 may generate a downsampled version of the complex RDS signal that is digitally sampled every 20/Tₛₐₘₚ seconds, for example.

The RDS demodulator 410 may comprise suitable circuitry, logic, and/or code that may be utilized to detect binary bits that may be encoded in an RDS signal.

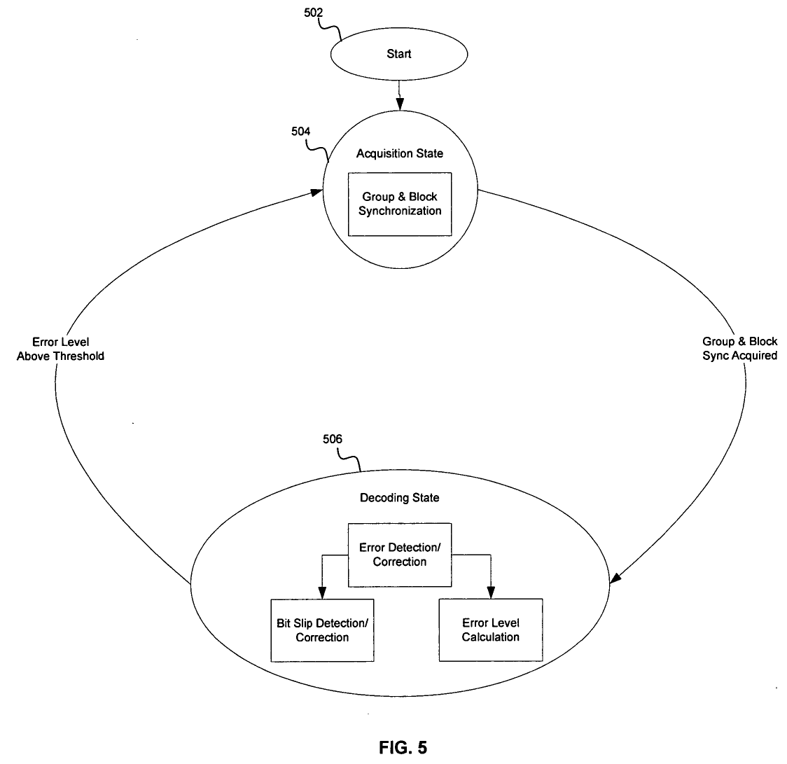

FIG. 5 is a flow diagram that illustrates exemplary steps for processing data in an RDS decoder in a single chip integrated Bluetooth and FM transceiver, in accordance with an embodiment of the invention. Referring to FIG. 4 and FIG. 5, after a starting step 502, in an acquisition step 504, the decoder 402 may receive a signal comprising audio information and/or data. During the acquisition step 504, the received signal may be synchronized. Once synchronization of the signal is achieved, the decoder 402 may decode the synchronized signal at a decoding step 506.

During the acquisition step 504, the RDS decoder 402 may run every time a bit is received. The decoder 402 may detect groups of encoded data blocks. The groups of data blocks may comprise 4 blocks, A, B, C/C′, and D. Each block of data may comprise 26 bits, where 16 bits comprise the encoded data, and 10 bits comprise a check word. The check word may be used for determining the received block. For example, the decoder 402 may detect an incoming block, and may look at the check word associated with the incoming block. The decoder 402 may then, based on the check word, determine whether the incoming block is A, B, C/C′, or D. As a result the decoder 402 may determine where it is looking within the group of blocks. The decoder 402 may determine that a group is detected when the decoder 402 detects each of the 4 blocks within the group. The decoder 402 may determine that synchronization is achieved when a certain number of data blocks are detected. The synchronized signal may then be decoded during a decoding step 506.

During the decoding step 506, error detection and correction may occur as well. Error detection and correction may comprise error level calculation and bit slip detection and correction. The bit slip detection and correction may determine when the data is misaligned. Often, a signal may be misaligned by one bit, for example, which may be detected and corrected by the decoder 402 during the decoding state 506. Sometimes, the signal may be misaligned by several bits, and that may be detected during the decoding step 506. If the amount of slip is greater than a specified threshold, it may be determined that the misalignment is too large, hence indicating that the signal may be out of synchronization. The signal may then be sent back at the acquisition step 504 to re-synchronize, before returning to the decoding step 506. In instances where the slip is less than the threshold, then the decoder may synchronize on its own without going back to the acquisition step 504.

The decoding step 506 may also involve error level calculation, to determine whether there are errors in the received signal. The decoding step 506 may therefore detect and correct errors in the signal, as part of the decoding of the signal.

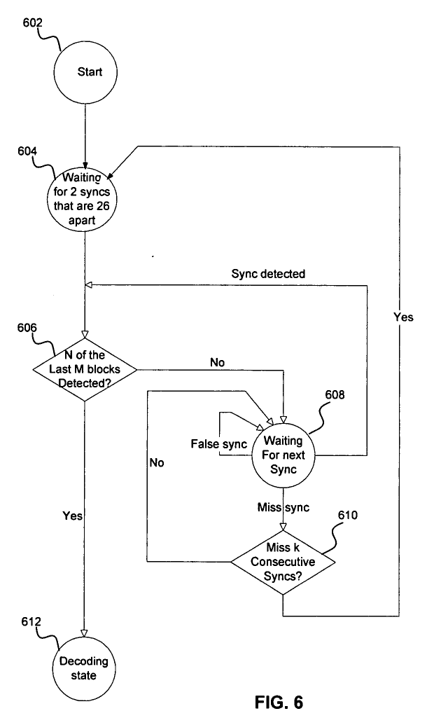

FIG. 6 is a flow diagram that illustrates exemplary steps for data acquisition in an RDS decoder in a single chip integrated Bluetooth and FM transceiver, in accordance with an embodiment of the invention. Referring to FIG. 4 and FIG. 6, after a starting step 602, the decoder 402 may begin the acquisition step 504 by detect groups of encoded data blocks, where a group of data blocks may comprise 4 blocks, A, B, C/C′, and D. Each block of data may comprise 26 bits, and the decoder 402 may determine whether the incoming block is A, B, C/C′, or D. As a result the decoder 402 may determine where it is looking within the group of blocks. The decoder 402 may determine that a group is detected when the decoder 402 detects each of the 4 blocks within the group. The decoder 402 may then determine that synchronization of an incoming signal is achieved if N blocks out of the latest M blocks are detected.

At an initial step 604 the decoder 402 may looks for two sync signals that are 26 bits apart. A sync signal may occur at the beginning of a block, A, B, C/C′, or D. Since the blocks are 26 bits long, detecting two syncs that are 26 bits apart may indicate detecting a block. At a next decision step 606, the decoder 402 may determine whether N blocks of the last M blocks were detected. In the simplest case, M and N may be set to 0, in which case, the decoder 402 may only look for two syncs 26 bits apart. In other cases where N and M are equal, the decoder 402 may look to detect N or M blocks in a row. For example, if N and M are set to 2, the decoder 402 may look to detect 3 syncs in a row, each two 26 bits apart. In some systems, N and M may be specified such that N is smaller than M, and the decoder 402 therefore may look for N blocks in an amount of bits of M blocks, or 26×M bits. For example, if N is 2 and M is 3, the decoder 402 may look for syncs indicating 2 blocks within a span of 3×26=78 bits.

If the last M blocks did not yield detection of N blocks, the decoder 402 may look for the next sync to detect another block at a step 608, and if a sync signal is found, then the decoder 402 may return to the decision block 606. Instead of a sync signal, the decoder 402 may detect a false sync signal, which may be caused by noise in the system. The decoder 402 may disregard such a signal and return to looking for the next sync signal. The decoder 402 may determine that a signal is a false sync signal if the number of bits between such a signal and a previous synch signal is not a multiple of 26, the size of a block, and the amount of bits between consecutive sync signals.

While waiting for a sync signal, the decoder 402 may also determine that a sync signal was missed, if the last detected sync is more than 26 bits prior to the currently detected signal. When the decoder 402 determines that a sync was missed, a decision may be made at a step 610 to determine whether k consecutive syncs were missed, where k=M−N+1. The number k may indicate when too many sync signals were missed that detecting N blocks in the last M blocks will not occur. If a determination is made that k consecutive syncs were missed, the decoder 402 may return to step 604 to look for 2 sync signals that are 26 bits apart. If a determination is made that k consecutive syncs were not missed, the decoder will go back to step 608 to wait for the next sync signal. For example, when N=2 and M=3, if 2 consecutive syncs are missed, then the decoder 402 returns to step 604.

If at the decision block 606 a determination is made that N block of the last M blocks were detected, then synchronization is achieved and the decoder 402 may begin the decoding step 612.

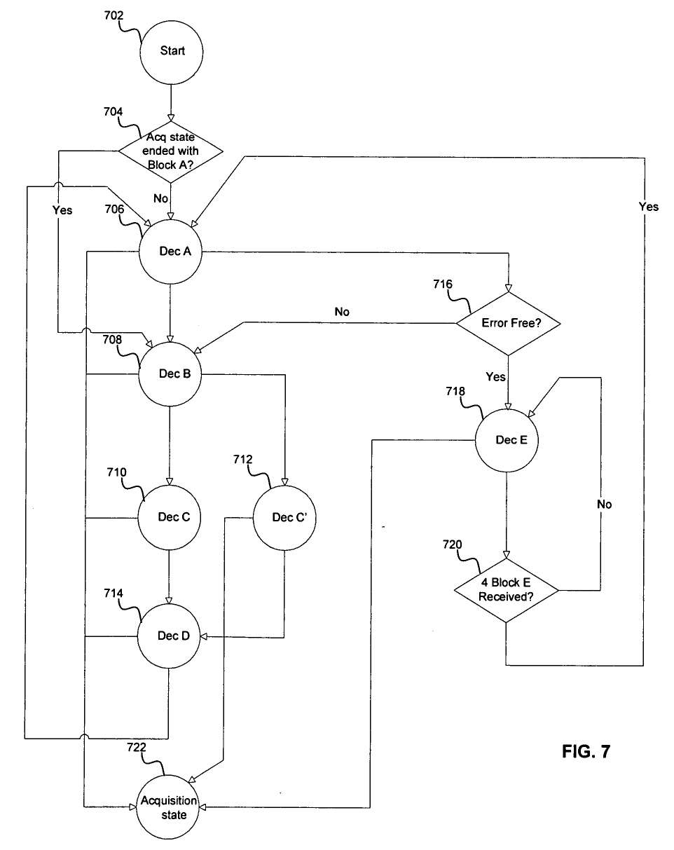

FIG. 7 is a flow diagram that illustrates exemplary steps for data decoding in an RDS decoder in a single chip integrated Bluetooth and FM transceiver, in accordance with an embodiment of the invention. During the decoding state, the decoder 402 may run every time 26 bits are received. Referring to FIG. 4 and FIG. 7, after a starting step 702, the decoder 402 may determine at a decision block 704 whether the acquisition state ended with block A, of the group of data blocks. The decoder 402, may for example, begin decoding at block A or block B, therefore, during the acquisition step, the decoder 402 may ensure that the first block in the decoding queue is either an A or B block. If the acquisition state did not end with block A, then the decoder 402 may determine that the block to be decoded is block A, and may decode block A at a next step 706. Then the next blocks B, C, and D may be decoded in that order at steps 708, 710, and 714, respectively. And the decoder 402 may go through after decoding block D at step 714, and restart with decoding the following block A at step 706.

While decoding each block, the decoder 402 may keep track of the error in the data stream and keep an accumulative error. If the decoder 402 determines that an error has accumulated through the data stream beyond a specified threshold, the decoder 402 may decide that the signal is out of sync. When the decoder 402 determines that the data steam is out of sync, the decoder may return to the acquisition state to re-establish synchronization at a step 722.

If the decoder 402 determines at the decision block 704 that the acquisition state did end with block A, that may indicate that the next block to decode is block B, and may decode block B at a next step 708. The decoder 402 may then go through and decode the block in order, C, D, then back to A, at steps 71, 714, and 706, respectively.

While decoding block B, it may be determined that the group of blocks A, B, C/C′, and D, may be such that it contains block C′ instead of C. When C′ is detected instead of C, after decoding block B at step 708, the decoder 402 may decode block C′ at step 712, then decode block D at step 714 and go through the same process back at decoding block A at step 706.

In some portions of the data stream, the signal may be multiplexed with MMBS. In such portions, the blocks of data may be identified as block E. The groups of data blocks in such portions may comprise 4 blocks of block E, and may be decoded differently than blocks A, B, C/C′, and D. When the decision is made at block 704 that the acquisition state did not end with block A, the decoder 402 may attempt to decode the following block as if decoding block A. However, if the block is block E, the decoder 402 may determine that the block is not block A, and may therefore determine whether there is an error in the data at a next decision step 716. If it is determined that there is an error in the block, then the decoder 402 may determine that the block to be decoded is block B and not A, and may decode the block B at a step 708, and go through the decoding process as described hereinabove.

If at the decision block 716, the decoder 402 determines that the block is error free, then that may indicate that the block is a block E, and may therefore decode it at a step 718. While decoding block E, if the decoder may check the error accumulation in the data stream, and if the decoder 402 determines that an error has accumulated through the data stream beyond a specified threshold, the decoder 402 may decide that the signal is out of sync. When the decoder 402 determines that the data steam is out of sync, the decoder may return to the acquisition state to re-establish synchronization at a step 722.

After decoding the block E, the decoder 402 may check the number of consecutive blocks E decoded. The decoder 402 may expect blocks E in groups of 4, and may determine at a decision step 720 whether 4 blocks E have been received. If less than 4 blocks E have been received and decoded, the decoder 402 may return to step 718 and continue decoding the blocks E. When 4 blocks E have been decoded, the decoder 402 may go back to its default decoding mode, by returning to step 706 and decoding the next block as block A.

Certain embodiments of the invention may comprise establishing synchronization of a bit stream based on detecting at least a portion of a plurality of received radio data service (RDS) data blocks. The bitstream may be decoded. If during decoding of the bitstream, at least a portion of the bit stream is out of synchronization, that portion of the bit stream may be synchronized by the decoder without having to enter an acquisition phase in order to re-establishing synchronization. If this synchronization fails during decoding, then decoding is suspended and synchronization is done in the acquisition phase.

An error level may be calculated during decoding and this error level may be utilized to determine whether to do synchronization in the decoding phase or whether to return to the acquisition phase to do synchronization. If the calculated error level is below a threshold, the bit stream may be synchronized without returning to the acquisition phase to establish synchronization. In this regard, the synchronization may be done in the decoding phase. If the error level is above the threshold, synchronizing of the bit stream may be done during the acquisition phase. Accordingly, decoding is suspended and synchronization done during the acquisition phase. During decoding, a synch signal may be detected in the data stream and a data block associated with the detected synch signal may be located. The located data block may be decoded based on a block type associated with said located data block.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for providing wireless communication, the method comprising:
establishing synchronization of a bit stream based on detecting at least a portion of a plurality of received radio data service (RDS) data blocks in an acquisition phase;
decoding said bit stream; and
if, during said decoding, at least a portion of said bit stream is out of synchronization, then synchronizing said at least a portion of said bit stream without said establishing of said synchronization during said acquisition phase.

2. The method according to claim 1, further comprising if, during said decoding, the at least a portion of said bit stream is out of synchronization and synchronization fails, then synchronizing said at least a portion of said bit stream by said establishing of said synchronization during said acquisition phase.

3. The method according to claim 1, further comprising calculating an error level of said bit stream during said decoding.

4. The method according to claim 3, further comprising, if said calculated error level is below a threshold, then synchronizing said bit stream without said establishing of said synchronization during said acquisition phase.

5. The method according to claim 3, further comprising, if said error level is above a threshold, then synchronizing said bit stream by said establishing of said synchronization during said acquisition phase.

6. The method according to claim 1, further comprising:
detecting a synch signal in said data stream during said decoding; and
locating a data block associated with said detected synch signal.

7. The method according to claim 6, further comprising decoding said located data block based on a block type associated with said located data block.

8. A machine-readable storage having stored thereon, a computer program having at least one code section for providing wireless communication, the at least one code section being executable by a machine for causing the machine to perform steps comprising:
establishing synchronization of a bit stream based on detecting at least a portion of a plurality of received radio data service (RDS) data blocks in an acquisition phase;
decoding said bit stream; and
if, during said decoding, at least a portion of said bit stream is out of synchronization, then synchronizing said at least a portion of said bit stream without said establishing of said synchronization during said acquisition phase.

9. The machine-readable storage according to claim 8, further comprising code for synchronizing said at least a portion of said bit stream by said establishing of said synchronization during said acquisition phase, if during said decoding, the at least a portion of said bit stream is out of synchronization and synchronization fails.

10. The machine-readable storage according to claim 8, further comprising code for calculating an error level of said bit stream during said decoding.

11. The machine-readable storage according to claim 10, further comprising code for synchronizing said bit stream without said establishing of said synchronization during said acquisition phase, if said calculated error level is below a threshold.

12. The machine-readable storage according to claim 10, further comprising code for synchronizing said bit stream by said establishing of said synchronization during said acquisition phase, if said error level is above a threshold.

13. The machine-readable storage according to claim 8, further comprising code for:
detecting a synch signal in said data stream during said decoding; and
locating a data block associated with said detected synch signal.

14. The machine-readable storage according to claim 14, further comprising code for decoding said located data block based on a block type associated with said located data block.

15. A system for providing wireless communication, the system comprising:
a single chip comprising an on-chip integrated FM radio, an on-chip integrated Bluetooth radio, and at least one on-chip processor communicatively coupled to said integrated FM radio and said integrated Bluetooth radio;
said at least one on-chip processor enables establishing of synchronization of a bit stream based on detecting at least a portion of a plurality of received radio data service (RDS) data blocks in an acquisition phase;
said at least one on-chip processor enables decoding said bit stream; and
said at least one on-chip processor enables synchronization of said at least a portion of said bit stream without said establishing of said synchronization during said acquisition phase, if during said decoding, at least a portion of said bit stream is out of synchronization.

16. The system according to claim 14, wherein said at least one on-chip processor enables synchronization of said at least a portion of said bit stream by said establishing of said synchronization during said acquisition phase, if during said decoding, the at least a portion of said bit stream is out of synchronization and synchronization fails.

17. The system according to claim 15, wherein said at least one on-chip processor enables calculation of an error level of said bit stream during said decoding.

18. The system according to claim 17, wherein said at least one on-chip processor enables synchronization of said bit stream without said establishing of said synchronization during said acquisition phase, if said calculated error level is below a threshold.

19. The system according to claim 17, wherein said at least one on-chip processor enables synchronization of said bit stream by said establishing of said synchronization during said acquisition phase, if said error level is above a threshold.

20. The system according to claim 15, wherein said at least one on-chip processor enables:
detection of a synch signal in said data stream during said decoding; and
locating data block associated with said detected synch signal.

21. The system according to claim 20, wherein said at least one on-chip processor enables decoding of said located data block based on a block type associated with said located data block.

22. The system according to claim 15, wherein said at least one on-chip processor comprises at least one of the following: an on-chip decoder and said at least one on-chip processor communicatively coupled to said integrated FM radio and said integrated Bluetooth radio.
